(19) United States
(12) Patent Application Publication
(10) Pub. No.: US 2007/0106784 A1
(43) Pub. Date: May 10, 2007

(54) Systems, methods and apparatus to identify network maintenance zones

(76) Inventor: David Thomas Dickman, Prospect, CT (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/268,920

(22) Filed: Nov. 8, 2005

(51) Int. Cl. G06F 15/173

(52) U.S. Cl. 709/224

(57) ABSTRACT

Systems, methods and apparatus are disclosed to identify network maintenance zones. An example system disclosed herein includes a network map database to receive and store location information of a network element. The example system further includes a repair database to receive and store repair data of the network element; and a network forecaster in communication with the repair database to identify network element rehabilitation zones based on the repair data.

### FIELD OF THE DISCLOSURE

This disclosure relates generally to network rehabilitation, and, more particularly, to systems, methods and apparatus to forecast network maintenance.

### BACKGROUND

Communication and utility networks typically include a service infrastructure to maintain, update and repair the networks. A network provider, whether it be for telecommunication services, intemet services, cable services, gas, water, and/or electric services, generally employs a fleet of service personnel or repair crews that respond to a trouble ticket. Such trouble tickets describe a network problem to the service personnel and provide a description of a network element suspected as the cause for the network problem.

In addition to applying one or more service personnel or repair crews from the fleet to solve known problems with the network, a network analyst or company/organization chartered with maintaining the network may apply preventative maintenance efforts to minimize future network issues. Because communication and utility networks are generally very large and include many network elements located throughout the network, the network analyst typically prioritizes geographic subsets of the network for equipment rehabilitation and preventative maintenance. Rehabilitation of such geographic network subsets, if selected properly, result in network robustness, reduced downtime, improved customer satisfaction, and/or cost savings due to a reduced need for field service crews.

Although benefits for network rehabilitation and preventative maintenance are apparent, forecasting geographic subsets that do not exhibit the greatest need for rehabilitation result in missed opportunities, increased network downtime, greater network maintenance expenses, and decreased customer satisfaction. Additionally, rehabilitating a geographic network subset in lieu of another geographic subset in greater need wastes limited funds that may be allocated on an annual basis for preventative maintenance and network rehabilitation.

### BRIEF DESCRIPTION OF THE DRAWINGS

FIG. 1 is a schematic diagram illustrating an example network rehabilitation forecaster constructed in accordance with the teachings of the detailed description.

FIG. 2 is a schematic diagram illustrating further details of the example network rehabilitation forecaster of FIG. 1.

FIGS. 3 and 4 are example maps generated by the example network rehabilitation forecaster of FIG. 1.

FIG. 5 is a schematic diagram illustrating further details of the example network rehabilitation forecaster of FIG. 1.

FIG. 6 illustrates an example user interface which may be displayed to a user of the example network rehabilitation forecaster of FIG. 1.

FIGS. 7 and 8 are example maps generated by the example network rehabilitation forecaster of FIG. 1.

FIGS. 9 and 10 are flow charts representative of example machine readable instructions which may be executed to implement the example network rehabilitation forecaster of FIG. 1.

FIG. 11 is a schematic illustration of an example computer which may execute the programs of FIGS. 9 and 10 to implement the example network rehabilitation forecaster of FIG. 1.

### DETAILED DESCRIPTION

Systems, methods and apparatus to identify network maintenance zones are disclosed. An example system includes a network map database to receive and store repair data of a network element, a repair database to receive and store repair data of the network element, and a network forecaster in communication with the repair database to identify network element rehabilitation zones based on the repair data. An example apparatus includes a repair database to receive and store network repair data, a network map database to provide network map data, and a network forecaster to determine a geographic network element rehabilitation zone from the network repair data. An example method may include recording locations of network elements serviced in a network and data associated with the network elements to create a service history database, and analyzing the recorded data and network locations to select a network element rehabilitation zone.

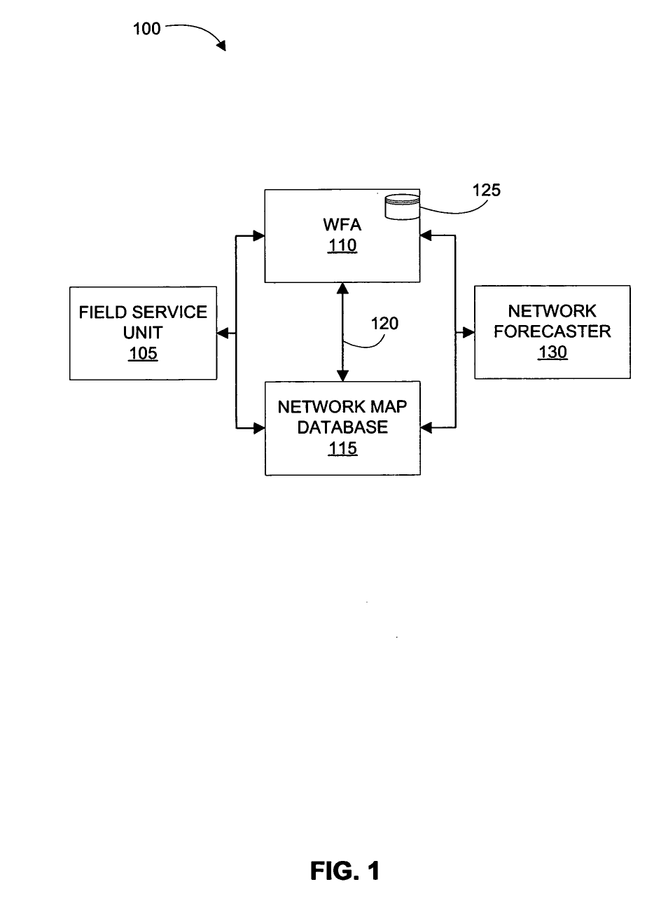

An example network rehabilitation forecaster 100 is shown in FIG. 1. As mentioned above, a service person or repair crew (hereinafter “technician”) responds to a trouble ticket before dispatch to a location of a network in need of repair. Such networks may include various communication networks for cable television, telephone and/or internet services. Additionally, the networks may include utility providers, such as gas, water and/or electricity. The technician servicing the network operates with a field service unit 105 to retrieve and send information regarding a network problem, discussed in further detail below.

The example network rehabilitation forecaster 100 also includes a resource administrator 110 (RA), such as a management application, and/or a work force administrator (WFA), such as a WFA by Telcordia®. The RA sends and receives information regarding a trouble ticket. For example, a customer may complain to a network provider (e.g., telephone provider, utility, intemet service provider, etc.) of no service, interrupted service, or any other network related problem. The complaint received by, for example, a customer service representative is entered into the RA 110 so that a technician is assigned to investigate the problem. The RA 110, which is communicatively connected to the field service unit 105, includes as much information as possible about the problem in an effort to aid the technician in the problem solving process.

Persons of ordinary skill in the art will appreciate that, prior to providing the technician with a trouble ticket via the RA 110, a remote diagnosis may be attempted without sending physical resources (e.g., a technician and associated support equipment) to the location(s) of the network problem and/or complaint. The remote diagnosis may attempt to verify and/or duplicate the service problem for which the customer complains. Such attempts allow the company/network analyst to narrow-down particular network sub-systems that may be responsible for the service problem. In particular, a network having network elements (NE's) that assist in the provisioning of services may be processor controlled, thereby having various communication capabilities. A telecommunication network, for example, may include advanced intelligent network (AIN) devices such as signal control points (SCP's) and signal switching points (SSP's), databases, and/or digital pair gain (DPG) devices, to name a few examples. Alternatively, a utility network, for example, may include intelligent power switches, regulation banks, and/or various transducers to provide operational metrics. The aforementioned NE's, if equipped with communication capabilities, may be queried during the remote diagnosis. The NE's communication capabilities may include telephone/modem access, a local area network (LAN) port, a General Purpose Interface Bus (GPIB), an RS-232 port, and/or a wireless access node that is uniquely addressable. The remote diagnosis attempts communication with the NE to ascertain error codes and/or status information. Such information returned by the NE (including a non-response, which may indicate a failed NE), is provided to the technician via the RA 110. If such information is provided prior to dispatch in the field, the technician may add potential replacement equipment to the service truck to minimize the number of trips to the suspected trouble location.

The example network rehabilitation forecaster 100 also includes a network map database 115 to provide the field service unit 105 with a map of the trouble location. Additionally, the network map database 115 contains geographic location coordinates (e.g., latitude and longitude) and/or records of various NE's in the network. As a result, a map may illustrate both spatial, road and/or other landmark information, as well as the various NE's proximate to such roads.

The network map database 115 is communicatively connected to the field service unit 105 so that the field service unit 105 may download maps relevant to a trouble ticket provided by the RA 110. Alternatively, the RA 110 may directly access 120 the network map database and download the relevant maps associated with the suspected trouble area and/or NE's. In this latter example, after the RA 110 combines the relevant map with the trouble ticket, the combination is forwarded to the field service unit 105.

Although the remote diagnostic attempts to identify exactly which NE(s) are the cause of the problem, and informs the technician exactly where that NE(s) are located, such information may not be available. In such a situation, the RA 110 makes no query to the network map database 115 and, instead, merely relays as much pertinent information as is presently available to the field service unit 105. The information may include the customer's account number, phone number, address, description of the problem, and/or time(s) that the problem occurred. The solution provided to the problem is dependent upon the skill and experience of the technician. As will be discussed in further detail below, when the technician solves the network problem and closes the trouble ticket, the technician identifies the location of the NE(s) with the field service unit 105. Furthermore, a global positioning system (GPS) provides and/or verifies the repaired NE(s) location(s). Updated trouble ticket information, including the identification of which NE(s) were repaired, when they were repaired, and where the repaired NE(s) are located, is uploaded to the RA 110. The updated trouble ticket information and/or service history information may be saved in a memory of the RA 110, saved in a repair database 125 of the RA 110, or saved in any other memory location or database within or outside the RA 110.

The example network rehabilitation forecaster 100 also includes a network forecaster 130 to analyze closed trouble ticket information and forecast geographic locations of the network having the greatest need for rehabilitation and/or preventative maintenance. As will be discussed in further detail below, the network forecaster 130 retrieves and/or queries data from the repair database 125, and applies one or more rules to the repair data in the repair database 125 in order to make preventative maintenance decisions. For example, the network forecaster 130 may run a query on the repair database 125 to retrieve a list of all repairs performed on the network in the past 6 months for repaired NE's within a one mile radius of a geographic network location of interest. Furthermore, the network forecaster 130 parses the query result for geographic indicia so that the network forecaster 130 may retrieve an appropriate map from the network map database 115. NE's identified in the repair database 125 query are assembled with the appropriate map from the network map database 115 by the network forecaster 130 to generate a map to illustrate the locations of the NE's matching the query rule(s). Generally speaking, a geographic location of the network that experiences a relatively high volume of service calls is a better rehabilitation candidate than another geographic location having fewer service calls. Although conventional wisdom may suggest that older geographic locations of the network should be rehabilitated first, such decisions are merely assumptions without the benefit of objective data, which may or may not actually be indicative of better rehabilitation candidates. As such, a user of the network forecaster 130 is presented with a graphical image of service repairs to identify optimum areas of the network to rehabilitate.

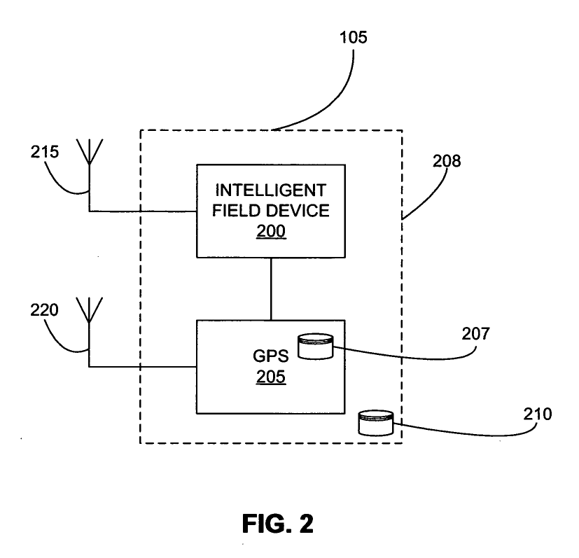

An example field service unit 105 is shown in FIG. 2. The example field service unit 105 includes an intelligent field device (IFD) 200, and a global positioning system receiver (GPS) 205, which may further include an optional memory 207 to store map data. The example field service unit 105 includes a housing 208 to secure and protect internal components from shock, vibration, and/or moisture. The housing 208 may also permit modular installation of the field service unit 105 in, for example, a field service vehicle. Additionally, the field service unit 105 includes an internal memory 210 to store trouble ticket information and/or map data, as discussed in further detail below. Each of the IFD 200 and GPS 205 is connected to an antenna 215 and 220, respectively. Communication of the IFD 200 is bidirectional via the antenna 215, whereas the antenna 220 for the GPS 205 is receive only.

The example field service unit 105 is carried by a service vehicle used by the technician when responding to the trouble tickets. The IFD 200 is a mobile computing device that may be designed for rugged conditions typical of field use. Such rugged design considerations may accommodate increased vibration, durability, impact resistance, and moisture blocking. Example mobile computing devices include, but are not limited to, laptops, hardened laptops, and personal digital assistants (PDA's) having a user screen (e.g., LCD display) to view a graphical user interface (GUI), data entry capabilities (e.g., keyboard, mouse, touchscreen) and external communication capabilities (e.g., network connectivity via LAN and/or WiFi, modem, cellular telephone, RS-232, etc.). The IFD 200 also includes a memory and/or communicatively accesses the internal memory 210 of the field service unit 105.

As discussed above, the field service unit 105 is communicatively connected to the RA 110 and the network map database 115. This connection may be affected via the aforementioned external communication capabilities, for example, by wirelessly connecting to the RA 110 via the bi-directional antenna 215 or a LAN connection. Typically, a technician is dispatched from a dispatch center that houses a fleet of service vehicles and technicians. Each of the vehicles of the fleet may include a field service unit that is communicatively connected to the RA 110 and the network map database 115. Upon receipt of a service ticket, data from the RA 110 and network map database 115 may be uploaded to the field service unit 105 associated with the technician assigned to the service ticket. Map data generally consumes a relatively large amount of memory that may be quickly transferred to the field service unit 105 via a high speed network at the dispatch center. Alternatively, if the field service unit 105 has already been dispatched to the field when a service ticket is assigned to the technician, such service ticket data and relevant network map data may be transferred to the field service unit via a mobile (e.g., cellular, GSM, etc.) phone and modem. An additional alternative is for the technician to visit WiFi hotspots on a periodic basis to check for service ticket updates, and send and/or receive data.

The GPS 205 may also store map data in memory 207. The map data in the GPS memory 207 may include standard street and road data that is generally provided with commercial GPS units. To illustrate NE locations relative to streets and roads, the IFD 200 may extract latitude and longitude coordinates from the service ticket, if available, and overlay those coordinates on maps provided by the GPS memory 207. Additionally, or alternatively, the GPS memory 207 may store map data specific to the network, thereby including location information for the NE's specific to the network.

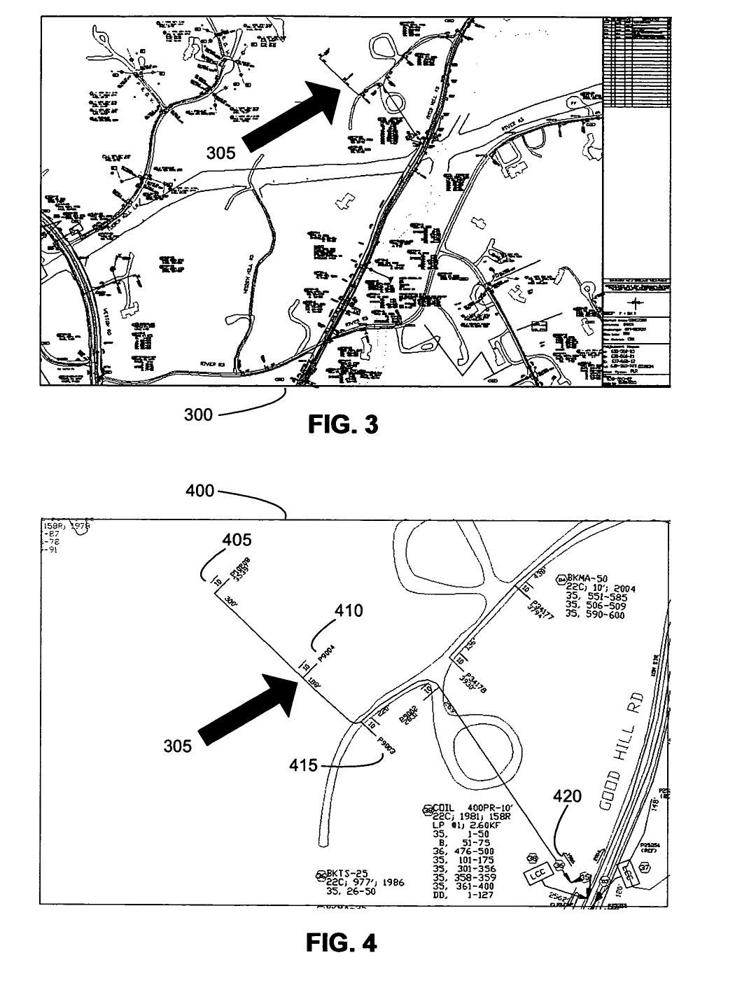

An example map 300 presented to the technician on the IFD 200 is shown in FIG. 3. An address of the customer complaining of a service problem is provided by the service ticket, extracted by the IFD 200, combined with a map, and shown to the technician by an arrow 305. Although the NE responsible for the service problem may not be located at the address of the customer, the technician may choose to investigate NE's in that vicinity as a troubleshooting starting point. To determine NE locations in the vicinity of the customer, the technician may zoom-in with the map and review NE placements, as shown in FIG. 4. The local view map 400 of FIG. 4 illustrates various NE's for the technician to investigate, such as utility poles (405, 410, 415) and a local exchange 420 that may include several NE's.

Because the example IFD 200 includes a touchscreen to display the GUI and/or a table, the technician may “pin-point,” or specifically select, the NE and/or location of the NE serviced on the local view map 400. For example, if the service problem reported by the customer located near the arrow 305 is caused by a NE in the local exchange 420, the technician touches the local exchange on the IFD 200 touchscreen to record closure of the trouble ticket. Furthermore, the GPS 205 may validate the location of the repaired and/or serviced NE with specific latitude and longitude coordinates. Such coordinates may be added to the closed trouble ticket for later processing, as will be discussed below.

The IFD 200 may store information (e.g., a service log) recorded by the technician after the repair is completed in the IFD 200 memory and/or the internal memory 210. Upon return to the dispatch center, the field service unit 105 may dock with the network to transfer service information to the RA 110. Additionally or alternatively, the IFD 200 may wirelessly transmit the repair data via the bidirectional antenna 215 before or after the technician returns to the dispatch center.

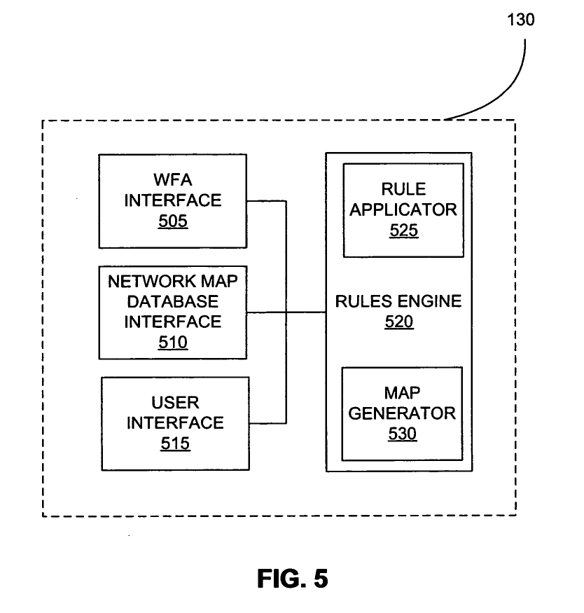

FIG. 5 is a more detailed schematic illustration of the example network forecaster 130 of FIG. 1. In the example of FIG. 5, the network forecaster 130 includes an RA interface 505 and a network map database interface 510, both of which are communicatively coupled to the RA 110 and the network map database 115, respectively. The example network forecaster 130 of FIG. 5 also includes a user interface 515 to allow a network analyst, or other person/employee/organization chartered with maintaining network health, to access the network forecaster 130. The example network forecaster 130 of FIG. 5 also includes a forecast engine 520 to determine geographic sub-groups of the network having the greatest need for rehabilitation. The forecast engine 520 includes a rule applicator 525 to apply predetermined rules to the repair data returned by one or more field service units 105. As discussed above, the data returned by the field service unit 105 is stored in the repair database 125 of the RA 110. The forecast engine also includes a map generator 530 to generate a map that graphically illustrates results of applying the pre-determined rules to the repair data.

Repair data from the RA interface 505 and map data from the network map database interface 510 is received by the forecast engine 520. The network analyst interacts with the user interface 515 to generate and/or design rules that process the repair data. The rules may act upon a variety of parameters, such as, repair dates, NE categories (e.g., switches, hubs, SCP's, etc.), distance between NE's repaired, and age of the NE's. For example, the network analyst may, via a graphic and/or tabular screen on the user interface 515, create a rule that searches the repair database 125 for all NE's repaired in the last six months. Furthermore, the network analyst may further narrow the results by applying a limiting parameter to restrict the results to those NE's within a 1/4 mile radius. When the network analyst completes the rule design, the rule may be saved for future use in a memory of the rule applicator 525. The rules may also enforce various density parameters, such as determining geographic zones of the network that include a predetermined threshold of repaired NE's per unit area (e.g., determine repaired NE's within a 1-mile radius when such NE's exceed a quantity of 15). Similarly, the density parameters may include a predetermined threshold of repaired NE's having a particular age (e.g., determine repaired NE's that are in service for more than 10 years when such NE's exceed a quantity of 100). The network analyst may accumulate a library of rules for quick recall and application by, for example, recalling a saved rule from a drop-down menu of the user interface 515.

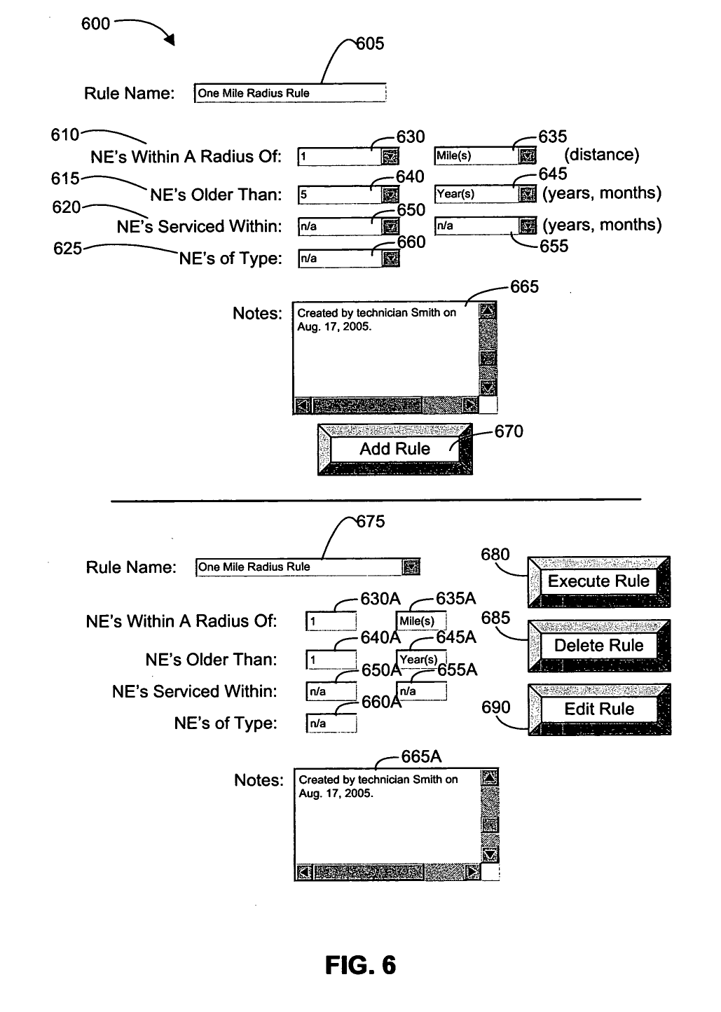

FIG. 6 is an example graphical user interface (GUI) 600 displayed by the user interface 515 of the network forecaster 130. When the network analyst designs a new rule, a rule name is entered into a rule name text field 605. Various example parameters of which the network analyst may populate or otherwise define a value for include “NE's Within a Radius of,” 610 “NE's Older Than,” 615 “NE's Serviced Within,” 620 and “NE's of Type” 625. Each of the example parameters (610, 615, 620, 625) includes one or more corresponding drop down menus to further specify particular metrics. For instance, the “NE's Within a Radius of” parameter includes a numeric drop down menu 630 with a particular range (e.g., 1 through 500), and a unit drop down menu 635 (e.g., feet, miles, meters, yards, etc.). Similarly, each of the “NE's Older Than” and “NE's Serviced Within” parameters include numeric drop down menus 640, 645 with a particular number (e.g., 1-20) and unit drop down menus 650, 655 (e.g., years, months, etc.), respectively. The “NE's of Type” parameter may include a drop down menu 660 having values of active, passive, switches, hubs, cable, pipe, utility pole, or any other such category that accommodates the network-type being analyzed by the network analyst. Persons of ordinary skill in the art will appreciate that not every parameter must be used when designing a rule. As such, a default setting for all drop down menus is set to “n/a” to indicate the parameter is not applied. The network analyst, or any other authorized user of the network forecaster 130, may enter notes in a text field 665. Upon completion of the network analyst configuring each of the parameters, an “Add Rule” button 670 is selected to save the rule to memory, thereby allowing the network analyst quick recall and the selected rule to the data in the repair database 125.

If the network analyst chooses to select a preconfigured rule rather than design a rule from “scratch,” the network analyst may select such a saved rule from a “Rule Name” drop down menu 675. Upon selection of the rule from the drop down menu 675, each of the parameters of that rule is populated in non-editable fields that directly correspond to the aforementioned parameters. To show this correspondence, the non-editable fields are labeled with the same reference numeral as the corresponding editable field followed by an “A” in FIG. 6. The network analyst may, thereafter, select an “Execute Rule” button 680 to apply the rule, a “Delete Rule” button 685 to delete the selected rule from memory, and/or an “Edit Rule” button 690 to edit the selected rule in memory.

The rule applicator 525 applies rules to the data of the repair database 125 to generate one or more results that satisfy the rule criteria. Furthermore, the map generator 530 applies the results from the rule applicator 525 to generate a graphical representation of the results. When the results from the rule applicator 525 includes one or more NE's, with each NE having a latitude and longitude coordinate, the map generator 530 produces a map of a relevant geographic sub-group encompassing the results. Such geographic sub-group further includes graphic indicia for each NE within that sub-group.

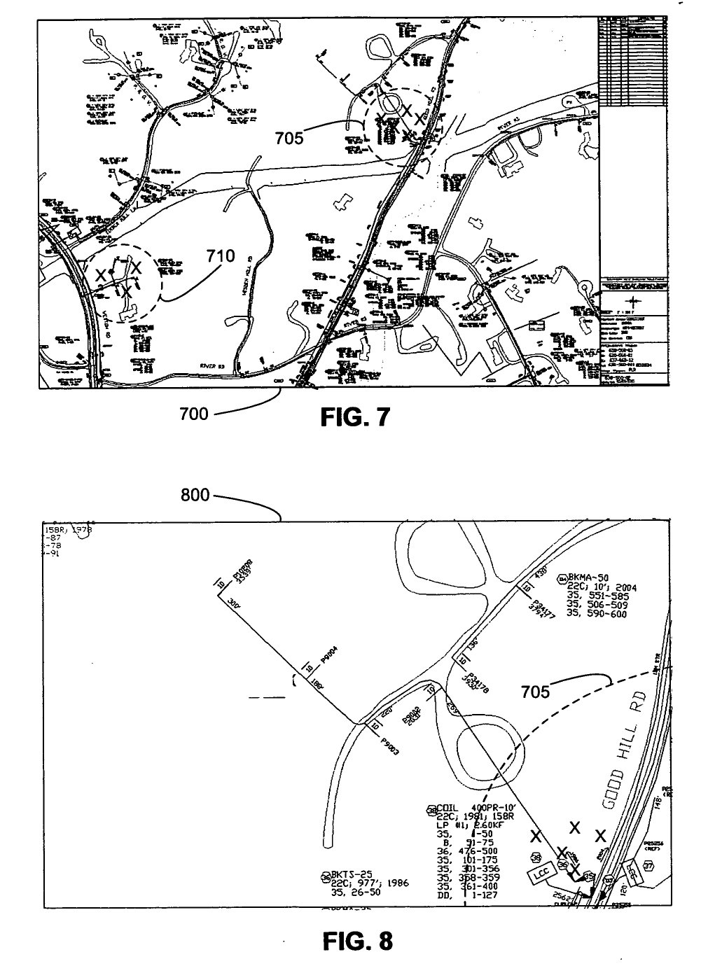

An example geographic sub-group illustrating an example result of applying an example rule to example repair data is shown in FIG. 7. The example geographic sub-group 700 illustrates two example clusters 705, 710, each of which satisfy example rule parameters. The network analyst, viewing the geographic sub-group 700 via the user interface 515, may easily identify that one of the two clusters (705) includes five repairs (as indicated by “X”), while the other cluster (710) includes only three repairs. The network analyst may further manipulate the map results and zoom-in to a local area 800, as shown in FIG. 8. As such, the network analyst may decide where to apply rehabilitation resources based on empirical results from the field, rather than making selections based only on assumptions and/or guesswork, as was done in the past. While the example repair data shown in FIG. 7 illustrates two separate clusters, persons of ordinary skill in the art will appreciate that any number of clusters may result from applying rules to the repair data. Furthermore, each cluster may represent results from an application of a single rule, or a combination of several rules.

Additionally, or alternatively, the network forecaster 130 may automatically determine where to apply rehabilitation resources, rather than rely upon a choice by the network analyst. For example, to save the network analyst time, or to avoid subjective factors in the decision making process, the network forecaster 130 may periodically invoke the rules engine 520 to analyze the repair data. If any predetermined thresholds are exceeded, as discussed above, the network forecaster 130 may generate a report and/or recommendation to apply rehabilitation resources to one or more geographic zones. As a result, the automatic analysis may bring much needed attention to network areas experiencing accelerated and/or increasing failures. Such automatic analysis is particularly beneficial when the network analyst forgets, or doesn't have the time, to run manual analysis procedures via the example GUI 600.

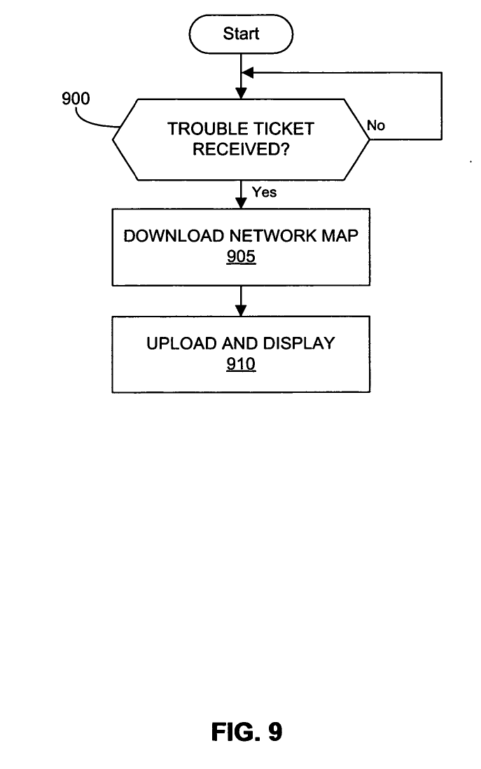

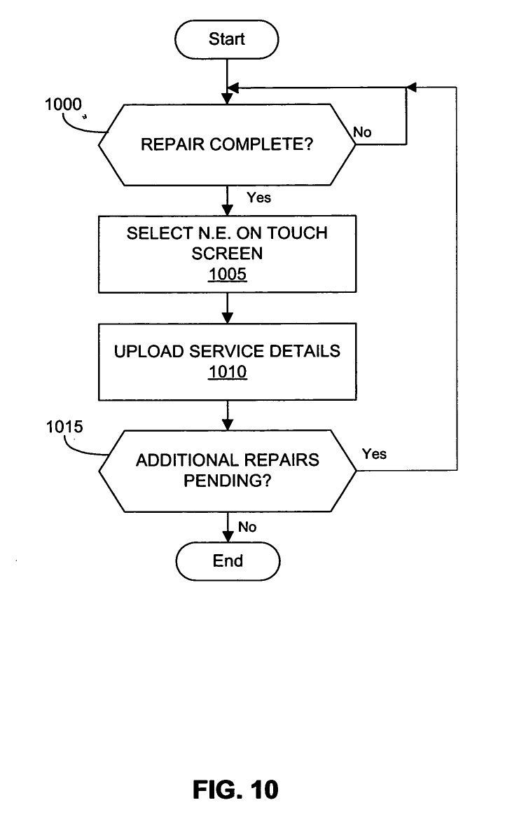

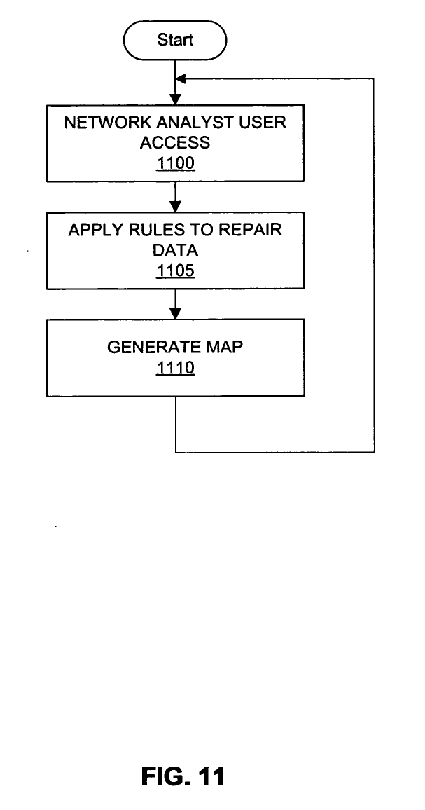

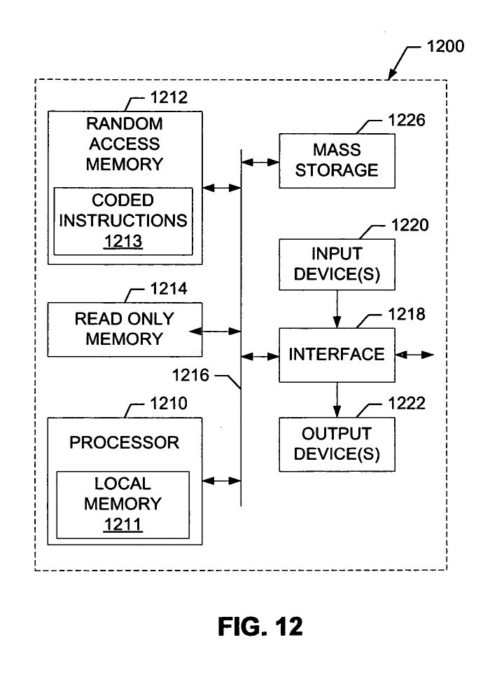

Flowcharts representative of example machine readable instructions for implementing the example network rehabilitation forecaster 100 of FIGS. 1, 2 and 5 are shown in FIGS. 9 and 10. In this example, the machine readable instructions comprise a program for execution by: (a) a processor such as the processor 1110 shown in the example computer 1100 discussed below in connection with FIG. 11, (b) a controller, and/or (c) any other suitable processing device. The program may be embodied in software stored on a tangible medium such as, for example, a flash memory, a CD-ROM, a floppy disk, a hard-drive, a digital versatile disk (DVD), or a memory associated with the processor 1 110, but persons of ordinary skill in the art will readily appreciate that the entire program and/or parts thereof could alternatively be executed by a device other than the processor 1 110 and/or embodied in firmware or dedicated hardware in a well-known manner (e.g., it may be implemented by an application specific integrated circuit (ASIC), a programmable logic device (PLD), a field programmable logic device (FPLD), discrete logic, etc.). For example, any or all of the network rehabilitation forecaster 100, the field service unit 105, the RA 110, the network map database 115, the repair database 125, the network forecaster 130, the IFD 200, the GPS 205, the RA interface 505, the network map database interface 510, the user interface 515, the forecast engine 520, the rule applicator 525, and/or the map generator 530 could be implemented by software, hardware, and/or firmware. Also, some or all of the machine readable instructions represented by the flowcharts of FIGS. 9 and 10 may be implemented manually. Further, although the example program is described with reference to the flow chart illustrated in FIGS. 9 and 10, persons of ordinary skill in the art will readily appreciate that many other methods of implementing the example machine readable instructions may alternatively be used. For example, the order of execution of the blocks may be changed, and/or some of the blocks described may be changed, substituted, eliminated, or combined.

The program of FIG. 9 begins at block 900 where the network rehabilitation forecaster 100 monitors for a trouble ticket issued by the RA 110 in response to, for example, a customer complaint regarding network performance and/or network service. If no complaints are received at block 900 or the complaints received are solved by the remote diagnosis as discussed above, then the program loops at predetermined intervals until the RA 110 issues a trouble ticket. When a trouble ticket is received (block 900), the RA 110 downloads a network map of the relevant locations of where the service problem is occurring (block 905). As discussed above, if the particular NE or NE's causing the service problem are unknown, the RA 110 may download a network map from the network map database 115 of a geographic location near the customer's address.

Both the network map downloaded from the network map database 115 to the RA 110, and the trouble ticket information are uploaded from the RA 110 to the field service unit 105 associated with the technician assigned to service the ticket (block 910). Furthermore, to provide the technician with graphical map information regarding the service destination, the map is displayed on the IFD 200, as shown in FIG. 3. Trouble ticket information may include, but is not limited to, the customer,s address, telephone number, account number, service trouble description, a list of NE,s associated with the customer's service and corresponding locations of those NE's.

Persons of ordinary skill in the art will appreciate that a technician typically services more than one trouble ticket each time the technician is dispatched. As such, blocks 900, 905 and 910 may iterate multiple times prior to, or during, the technician dispatch and populate the field service unit 105 with multiple trouble tickets in need of servicing. The program of FIG. 10 begins at block 1000 where a technician services a trouble ticket. While the technician is servicing the pending trouble ticket, the program loops (block 1000). Upon completion of a repair, the technician selects, via the touchscreen of the IFD 200, the NE that was repaired to address the service and/or network problem (block 1005). In the event that the IFD 200 has previously downloaded the network map, or a portion thereof, various NE's may be visible to the technician on the IFD 200 touchscreen. Moreover, the NE's may be displayed on the touchscreen with geographic coordinates relative to roads, streets, lakes, buildings, and/or other map landmarks. The technician's selection of the repaired NE(s) on the touchscreen causes spatial coordinates (latitude and longitude) to be recorded, thereby indicating where the repaired NE was located. However, in the event that the network map was not downloaded to the IFD 200 prior to the technician's dispatch, and/or if the network map database 115 is incomplete, the GPS 205 may validate the technician,s selection by obtaining a real-time spatial data point (e.g., latitude and longitude coordinate) and adding that data point to the closed trouble ticket. The GPS 205 validation may also accommodate for inadvertent pin-point selection errors by the technician, thereby ensuring reliable data of the repair for post analysis.

Upon the service technician,s return to the dispatch center, or upon closure of the trouble ticket, the field service unit 105 uploads service details of the trouble ticket to the repair database 125 of the RA 110 (block 1010). Service details may include, but are not limited to, information in the trouble ticket, as discussed above. Additionally, the service details uploaded to the repair database 125 may include technician notes, recommendations, disposition codes, and/or cause codes. Disposition codes may include several fields, such as, a category parameter (e.g., network, cable, central office, etc.), a description parameter (e.g., ground-wire, network interface device, defective pair, etc.), a numeric or alpha-numeric detail code, and/or a definition parameter describing the disposition code. Persons of ordinary skill in the art will appreciate that service details may be custom tailored to accommodate any network type and use corresponding terminology and/or codes associated with such network types. As discussed above, uploading the service details may be accomplished via a network connection at the dispatch center, a WiFi connection, and/or a wireless connection via mobile phone and modem. If the service technician is responsible for additional repairs (block 1015), the program returns to block 1000 to wait for repair completion. However, if the technician is not responsible for additional repairs (block 1015) because, for example, the technician,s daily work-shift is over or all repairs at a site are completed, the program ends. The service details are then available for network forecasting, discussed below in connection with FIG. 11.

A flowchart representative of example machine readable instructions for implementing the example network forecaster 100 of FIGS. 1, 2, and 5 is further shown in FIG. 11. In particular, the example machine readable instructions of FIG. 11 illustrate network forecasting by the network forecaster 130. The program of FIG. 11 begins at block 1100 where the network administrator accesses the user interface 515 to control network forecasting operations. Various user interface graphics, menus, buttons and/or tables permit the network administrator with forecasting rule design, selection, and/or execution, as discussed above in connection with FIG. 6. After the network administrator creates, edits, and selects a rule (block 1100), the rule applicator 525 of the forecast engine 520 queries the repair database 125 of the RA 110 via the RA interface 505. An example RA interface 505 is a database query engine, such as a structured query language (SQL) engine (e.g., SQL Server). Rule constraints applied to the query at block 1105 return results matching the various parameters established by the rule. For example, if the parameter “NE's Older Than” is set to 5-years, then the database query results will not return NE coordinates for any NE,s below the threshold of 5-years of age.

Results from the database query are further processed by the map generator 530 of the forecast engine 520 at block 1110. The map generator 530 evaluates all coordinates of the NE's returned by the rule applicator 525 query to determine appropriate geographic sub-sections of the network map to display. The map generator 530 accesses the network map database 115 via the network map database interface 510. The network map database interface 510 may be implemented by, for example, a spatial database engine (SDE) developed by the Environmental Systems Research Institute, Inc. (ESRI). The map generator 530 combines the spatial NE coordinates returned by the rule applicator 525 query to the relevant geographic sub-sections of the network map (block 1110) so that the network analyst may view a spatial representation of the results via the user interface 515. As discussed above in connection with FIGS. 7 and 8, the maps generated and shown to the network analyst (block 1110) allow the network analyst to quickly see which particular geographic sub-sections of the network have had service as a result of trouble tickets. The network analyst may then make informed network rehabilitation decisions based on empirical repair data instead of other less reliable decision-making methods (e.g., based only on NE age). If the network analyst chooses to execute additional and/or alternate rules on the same and/or alternate repair data, the program loops back to block 1100.

FIG. 12 is a block diagram of an example computer 1200 capable of implementing the apparatus and methods disclosed herein. The computer 1200 can be, for example, a server, a personal computer, a laptop, a PDA, or any other type of computing device.

The system 1200 of the instant example includes a processor 1210 such as a general purpose programmable processor. The processor 1210 includes a local memory 1211, and executes coded instructions 1213 present in the local memory 1211 and/or in another memory device. The processor 1210 may execute, among other things, the example machine readable instructions illustrated in FIGS. 9 and 10. The processor 1210 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1210 is in communication with a main memory including a volatile memory 1212 and a non-volatile memory 1214 via a bus 1216. The volatile memory 1212 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1214 may be implemented by flash memory and/or any other desired type of memory device. Access to the main memory 1212, 1214 is typically controlled by a memory controller (not shown) in a conventional manner.

The computer 1200 also includes a conventional interface circuit 1218. The interface circuit 1218 may be implemented by any type of well known interface standard, such as an Ethernet interface, a universal serial bus (USB), and/or a third generation input/output (3GIO) interface.

One or more input devices 1220 are connected to the interface circuit 1218. The input device(s) 1220 permit a user to enter data and commands into the processor 1210. The input device(s) can be implemented by, for example, a keyboard, a mouse, a touchscreen, a track-pad, a trackball, isopoint and/or a voice recognition system.

One or more output devices 1222 are also connected to the interface circuit 1218. The output devices 1122 can be implemented, for example, by display devices (e.g., a liquid crystal display, a cathode ray tube display (CRT), a printer and/or speakers). The interface circuit 1218, thus, typically includes a graphics driver card.

The interface circuit 1218 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1200 also includes one or more mass storage devices 1126 for storing software and data. Examples of such mass storage devices 1226 include floppy disk drives, hard drive disks, compact disk drives and digital versatile disk (DVD) drives. The mass storage device 1226 may implement the network map database 115 and/or the repair database 125.

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A system to identify network rehabilitation zones based on repair data comprising:
a network map database to receive and store location information of a network element;
a repair database to receive and store repair data of the network element; and
a network forecaster in communication with the repair database to identify network element rehabilitation zones based on the repair data.

2. A system as defined in claim 1 further comprising a field unit to receive data associated with a trouble ticket and to submit the repair data of the network element to the repair database.

3. A system as defined in claim 2 further comprising a resource administrator communicatively connected to the field unit to assign the trouble ticket.

4. A system as defined in claim 2 wherein the field unit comprises an intelligent field device.

5. A system as defined in claim 4 wherein the intelligent field device comprises at least one of a laptop or a personal digital assistant.

6. A system as defined in claim 4 wherein the intelligent field device comprises a display unit.

7. A system as defined in claim 6 wherein the display unit comprises a touchscreen and a graphical user interface.

8. A system as defined in claim 4 wherein the intelligent field device is adapted to wirelessly communicate to at least one of the repair database or the network map database.

9. A system as defined in claim 1 wherein the repair data of the network element comprises at least one of a network element name, a network element coordinate, or a network element repair date.

10. A system as defined in claim 1 wherein the network forecaster comprises a rules engine to apply rules to the repair data.

11. A system as defined in claim 10 wherein the rules engine comprises a rule applicator and a map generator to generate a graphical representation of the repair data.

12. A system as defined in claim 10 wherein the rules applied to the repair data include at least one of distance limits, density limits, age limits, service date limits, or network element type limits.

13. A system as defined in claim 11 wherein the map generator generates the graphical representation of the repair data comprising a plurality of network element rehabilitation zones.

14. A system as defined in claim 13 wherein at least one rule applies to each of the plurality of network element zones.

15. A system as defined in claim 13 wherein different rules apply to each of the plurality of network element zones.

16. A system as defined in claim 1 further comprising a rehabilitation zone selection algorithm.

17. A system as defined in claim 16 wherein the rehabilitation zone selection algorithm automatically determines the network element rehabilitation zone.

18. A system as defined in claim 16 wherein the rehabilitation zone selection algorithm comprises a predetermined density threshold.

19. A system as defined in claim 18 wherein the predetermined density threshold comprises at least one of number of repaired network elements per unit area, number of network elements of a predetermined age per unit area, or number of network elements of a predetermined type per unit area.

20. A system as defined in claim 1 wherein the network forecaster comprises a user interface.

21. A system as defined in claim 20 wherein the user interface is at least one of a graphical user interface or a table.

22. A system as defined in claim 20 wherein the user interface comprises at least one of a rule design interface or a rule execution interface.

23. A system as defined in claim 1 further comprising a plurality of field units.

24-41. (canceled)

42. A method to select network rehabilitation comprising:
recording locations of network elements serviced in a network and data associated with the network elements to create a service history database; and
analyzing the recorded data and network locations to select a network element rehabilitation zone.

43. A method as defined in claim 42 further comprising validating the locations of network elements serviced in the network with an intelligent field device.

44. A method as defined in claim 43 wherein the intelligent field device receives geographic coordinates from a GPS unit.

45. A method as defined in claim 43 wherein the intelligent field device wirelessly communicates with a resource administrator.

46-58. (canceled)

59. An article of manufacture storing machine readable instructions which, when executed, cause a machine to:
record location data and network element data of serviced network elements; and
analyze the location data and network element data to identify a network element rehabilitation zone.

60-76. (canceled)
